(19) United States
(12) Patent Application Publication
(10) Pub. No.: US 2024/0256952 A1
(43) Pub. Date: Aug. 1, 2024

(54) METHOD AND SYSTEM FOR TOKEN BASED CLASSIFICATION FOR REDUCING OVERLAP IN FIELD EXTRACTION DURING PARSING OF A TEXT

(71) Applicant: Innoplexus AG, Eschborn (DE)

(72) Inventors: Sudhanshu Kumar, Bokaro (IN); Shubham Patel, Satna (IN)

(73) Assignee: Innoplexus AG, Eschborn (DE)

(21) Appl. No.: 18/161,325

(22) Filed: Jan. 30, 2023

(51) Int. Cl. G06N 20/00; G06F 16/35

(52) U.S. Cl. CPC G06N 20/00; G06F 16/355

(57) ABSTRACT

A system and a method for token-based classification for reducing overlap in field extraction during parsing of a text is disclosed. The method includes extracting text from a resource. The method further includes splitting one or more sentences into a predetermined number of plurality of tokens. The method furthermore includes generating a plurality of lists using a machine learning model for identifying one or more fields in the text. The plurality of lists comprises at least a list of tokens, a list of tags and a list of confidence scores of tokens. The method furthermore includes post processing the plurality of lists for extracting one or more fields for parsing the text.

### BACKGROUND

### Technical Field

The present invention is generally related to the field of data processing. More particularly, the present invention is related to a method and system for token-based classification for reducing overlap in field extraction during parsing of a text.

### Description of the Related Art

Generally, there is a lot of information in documents. Document extraction is one of the complex as well as important tasks in the field of natural language processing. There are a lot of business use cases that thrive from the information extracted from documents. Few examples are extracting information from invoices, extracting information from insurance documents, from medical reports, from contracts, from publication and patents. Therefore, there are several open source and paid tools available to extract data from complex documents. However, extracting information from portable document formats (PDFs) has always been tricky because of different formats they come in, such as one column vs multi column, text in paragraphs, tables, diagrams, charts, and the like. Engineers and data scientists try to extract relevant information in terms of fields of text from different locations in the PDF. One such example is PDFs created after the conferences. Typically, the pdf from a conference consists of information about more than one topic. They primarily contain title, author, affiliation and abstract information and the information can be used in multiple cases such as research, identification of key opinion leaders in a particular field, identifying ongoing research in an institution, and the like.

Currently, there are a lot of tools to extract data from PDFs such as Camelot, Tabula, pymupdf, pdfminer and so on. One of the most common problems experienced while using the known techniques of extracting data from the PDFs is that during extraction from any of these tools is the merging of fields. Also, there are a variety of inbuilt modules and optical character recognitions (OCRs) for text extraction. However, the inbuilt modules use sentence-based classification or named entity recognition (NER) from a given text. But none of them work on classifying each token into a particular category. Also, the existing techniques use open-source models such as, spacy or BERT to extract NER such as name and location. By using a PERSON tag from NER, we can get author name and LOCATION, ORGANIZATION that provides the Affiliation tags and then through post processing, index split and Tags split can be used to get the desired articles. However, in such techniques sometimes the Title contains an Organization and Location name which is detected by NER and then some part of the title comes into Author or Affiliation, which is not desired. Also, sometimes NER might not be that accurate to detect classes and thus leads to misclassification of the text. Additionally, sentence classification does not work when partial text information is misclassified as shown in example above because these models work on sentence segmentation and sometimes it is not clear where a sentence begins and where it ends. Moreover, the NER model does not care about stop words or non-target words such as “the”, “more”, etc. They can extract only the relevant keywords.

FIGS. 1A-1C contain some of the common format of congress PDFs. While in FIG. 1A we can observe that Author, Affiliation, Title, and Abstract fields are all separated, but chances are that during the extraction process some of the words/tokens from a field get merged into another. For example, in FIG. 1 “Leonardo to Galileo” are names of persons in the title section. But due to parsing and using NER, they may be identified as authors and get misclassified into incorrect fields. Similarly, in the images in FIG. 1B and FIG. 1C, we can see that the text does not have very clear boundaries to separate fields like title, author, affiliation and abstract and there are higher chances of misclassification of some of the tokens from one field to get overlapped with another. For example, “The Netherlands” in the third line of FIG. 1B gets merged into affiliation because of a similar entity type. This problem is more common than expected in document parsing.

Accordingly, there is a need for an efficient technique that can disambiguate the two kinds of data by identifying the starting and ending index of that entity, which helps in representing the complete information in structured format.

The above-mentioned shortcomings, disadvantages and problems are addressed herein, and will be understood by reading and studying the following specification.

### SUMMARY

This summary is provided to introduce a selection of concepts in a simplified form that are further disclosed in the detailed description. This summary is not intended to determine the scope of the claimed subject matter.

The embodiments herein address the above-recited needs for a system and a method that can differentiate a token from one another and resolve the merging problem that arises during data extraction using a machine learning model. In the present technology, the plain text is extracted from PDFs using optical character recognition (OCR) without the use of any meta-information of text, since the text having bold and italic like characters does not affect the performance of the machine learning model. The present technology provides an efficient technique for token-based classification for reducing overlap in field extraction during parsing of a text.

According to one aspect, a processor implemented method of token-based classification for reducing overlap in field extraction during parsing of a text is provided. The method includes extracting the text from a resource. The method also includes splitting sentences in the text into a predetermined number of tokens. The method further includes generating a plurality of lists using a machine learning model for identifying one or more fields in the text. The plurality of lists comprises at least a list of tokens, a list of tags and a list of confidence scores of tokens. The method furthermore includes post processing the plurality of lists for extracting one or more fields for parsing the text.

In an embodiment, extracting the text from the resource comprises receiving a PDF document and identifying one or more bounding boxes in text from the PDF document, converting the one or more bounding boxes into a plurality of images and parsing the text from each section of the plurality of images.

In an embodiment, generating the plurality of lists comprises classifying the one or more sentences with a plurality of labels, splitting the classified sentences into one or more tokens, and passing the one or more tokens into a classifier for generating the plurality of lists. According to another aspect, a processor-implemented method of training a machine learning model for token-based classification for reducing overlap in field extraction during parsing of text is provided. The method includes extracting the text from a resource. The method also includes generating a training set for the artificial intelligence model based on the extracted text and importing the training set into the artificial intelligence model. The method further includes training and evaluating the artificial intelligence model using the training set for generating a plurality of lists using a machine learning model, for identifying one or more fields in the text, wherein the plurality of lists comprises at least a list of tokens, a list of tags and a list of confidence score of tokens.

In an embodiment, the machine learning model is a Cased-Sci-Bert model.

According to yet another aspect, a system for token-based classification for reducing overlap in field extraction during parsing of a text is provided. The system includes a processor configured to execute non-transitory machine-readable instructions that when executed causes the processor to extract the text from a resource, split one or more sentences in the text into a predetermined number of tokens, generate a plurality of lists using a machine learning model for identifying one or more fields in the text, the plurality of lists including at least a list of tokens, a list of tags and a list of confidence score of tokens, and post process the plurality of lists for extracting one or more fields for parsing the text.

In an embodiment, extracting the text from the resource comprises receiving a PDF document and identifying one or more bounding boxes in text from the PDF document, converting the one or more bounding boxes into a plurality of images and parsing the text from each section of the plurality of images.

In an embodiment, generating the plurality of lists comprises classifying the one or more sentences with a plurality of labels, splitting the classified sentences into one or more tokens, and passing the one or more tokens into a classifier for generating the plurality of lists.

The present technology provides a method and a system that can differentiate a token from one another and resolve the merging problem that arises during data extraction using a machine learning model. The present technology provides an efficient technique for classifying and splitting a paragraph into a structured format using machine learning models. The method and system of the present technology enables a user to make their own database with large pieces of unstructured text and any relevant information associated with a document being parsed.

It is to be understood that the aspects and embodiments of the disclosure described above may be used in any combination with each other. Several of the aspects and embodiments may be combined to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

These and other objects and advantages will become more apparent when reference is made to the following description and accompanying drawings.

### BRIEF DESCRIPTION OF THE DRAWINGS

The other objects, features and advantages will occur to those skilled in the art from the following description of the preferred embodiment and the accompanying drawings in which:

FIGS. 1A-1C depict some of the common format of congress PDFs, in accordance with an exemplary scenario.

FIG. 1D depicts a system for token-based classification for reducing overlap in field extraction during parsing of a text, in accordance with an embodiment.

FIG. 2 depicts a block flow diagram illustrating the process of token-based classification for reducing overlap in field extraction during parsing of a text, in accordance with an embodiment.

FIG. 3 depicts exemplary bounding boxes in a PDF document, in accordance with an exemplary scenario.

FIG. 4 depicts an excerpt from a PDF document, in accordance with an exemplary scenario.

FIG. 5A depicts an exemplary text, in accordance with an exemplary scenario.

FIG. 5B depicts a pre-trained version of BERT model, in accordance with an exemplary scenario.

FIG. 6 illustrates a flow diagram depicting processor-implemented method of training a machine learning model for token-based classification for reducing overlap in field extraction during parsing of a text, in accordance with an embodiment.

FIG. 7 illustrates a flow diagram depicting processor-implemented method of token-based classification for reducing overlap in field extraction during parsing of a text, in accordance with an embodiment.

FIG. 8 depicts a representative hardware environment for practicing the embodiments herein.

Although the specific features of the embodiments herein are shown in some drawings and not in others. This is done for convenience only as each feature may be combined with any or all of the other features in accordance with the embodiments herein.

### DETAILED DESCRIPTION OF THE DRAWINGS

The detailed description of various exemplary embodiments of the disclosure is described herein with reference to the accompanying drawings. It should be noted that the embodiments are described herein in such details as to clearly communicate the disclosure. However, the amount of details provided herein is not intended to limit the anticipated variations of embodiments; on the contrary, the intention is to cover all modifications, equivalents, and alternatives falling within the spirit and scope of the present disclosure as defined by the appended claims.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

While the disclosure is susceptible to various modifications and alternative forms, specific embodiment thereof has been shown by way of example in the drawings and will be described in detail below. It should be understood, however, that it is not intended to limit the disclosure to the forms disclosed, but on the contrary, the disclosure is to cover all modifications, equivalents, and alternatives falling within the scope of the disclosure.

The detailed description of various exemplary embodiments of the disclosure is described herein with reference to the accompanying drawings. It should be noted that the embodiments are described herein in such details as to clearly communicate the disclosure. However, the details provided herein is not intended to limit the anticipated variations of embodiments; on the contrary, the intention is to cover all modifications, equivalents, and alternatives falling within the spirit and scope of the present disclosure as defined by the appended claims.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

While the disclosure is susceptible to various modifications and alternative forms, specific embodiment thereof has been shown by way of example in the drawings and will be described in detail below. It should be understood however, it is not intended to limit the disclosure to the forms disclosed, but on the contrary, the disclosure is to cover all modifications, equivalents, and alternatives falling within the scope of the disclosure.

The various embodiments of the present technology provide a system and a method that can differentiate a token from one another and resolve the merging problem that arises during data extraction using a machine learning model. In the present technology, the plain text is extracted from portable document format (PDF)s using optical character recognition (OCR) without the use of any meta-information of text, since the text having bold and italic like characters does not affect the performance of the machine learning model. The present technology provides an efficient technique for classifying and splitting a paragraph into a structured format using machine learning models.

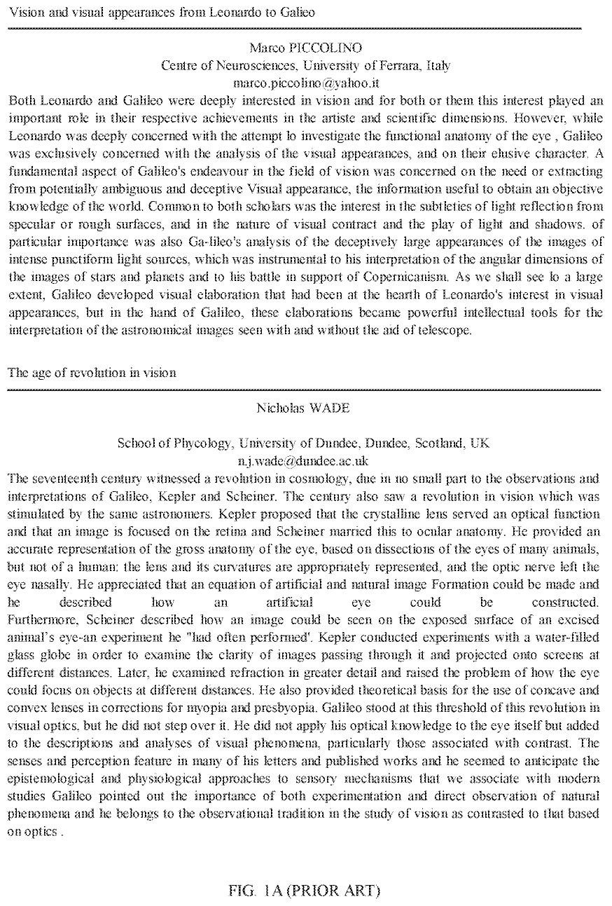

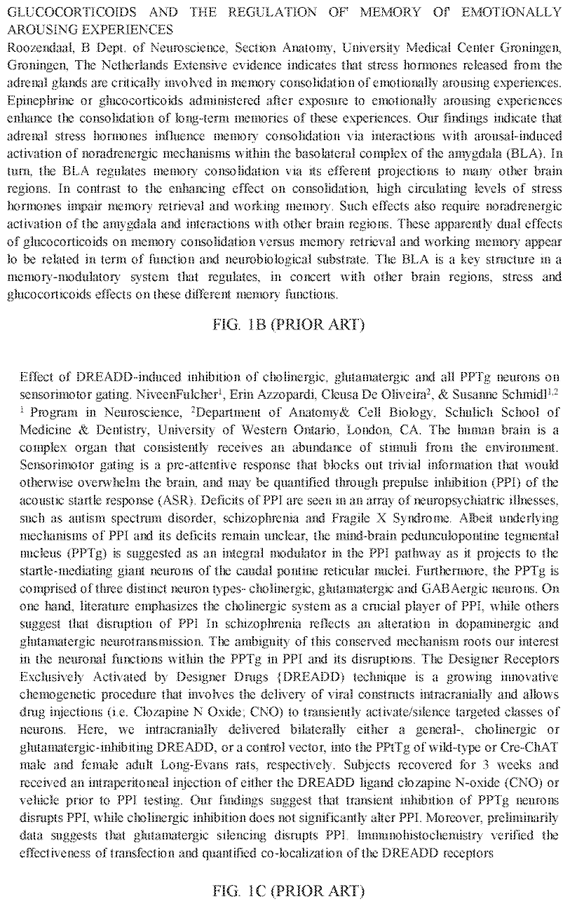

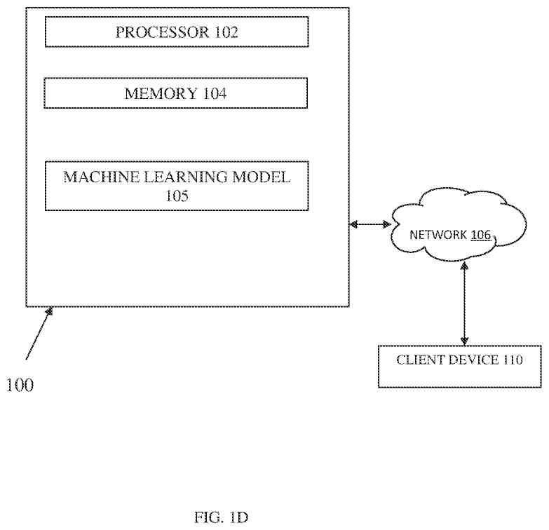

Referring to FIG. 1D, FIG. 1D depicts a system 100 for token-based classification for reducing overlap in field extraction during parsing of a text, in accordance with an embodiment. The system 100 includes a processor 102 with a memory 104 comprising executable non-transitory machine-readable instructions wherein the processor 102 is configured to execute the said machine-readable instructions. The system 100 includes a processor 102 and a memory 104. The processor 102 is communicably coupled to a client device 110 via a data communication network 106. The network 106 may be for example, a private network and a public network, a wired network or a wireless network. The wired network may include, for example Digital Subscriber Line (DSL), coaxial cable lines, or optical fiber lines. The wireless network may include for example Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, a satellite band and other similar wireless networks. The wireless networks may also include any cellular network standards to communicate among mobile devices. Examples of the client device 110 includes but is not limited to user devices (such as cellular phones, personal digital assistants (PDAs), handheld devices, laptop computers, personal computers, an Internet-of-Things (IoT) device, a smart phone, a machine type communication (MTC) device, a computing device, a drone, or any other portable or non-portable electronic device. According to some embodiments, the system 100 may be implemented in a variety of computing systems, such as a mainframe computer, a server, a network server, a laptop computer, a desktop computer, a notebook, a workstation, and the like. In an implementation, the system 100 may be implemented in a server or in a computing device. In some embodiments, the system 100 may be implemented as a part of a cluster of servers. In some embodiments, the system 100 may be performed by the plurality of servers. These tasks may be allocated among the cluster of servers by an application, a service, a daemon, a routine, or other executable logic for task allocation.

The processor 102 is configured to extract text from a resource. The resource may include for example a PDF file. The text from the PDF is extracted using optical character recognition (OCR). Typically, the PDF contains a lot of noise, such as details, header, footer and the like. To remove the noise, noise data is extracted from the PDF and the data is created manually to obtain text and their annotations. In an embodiment, the processor 102 identifies one or more bounding boxes in the text from the PDF document. The processor 102 converts the one or more bounding boxes into a plurality of images. The processor 102 parses the text from each section of the plurality of images.

The processor 102 is configured to split the one or more sentences in the text into a predetermined number of plurality of tokens. The processor 102 classifies the one or more sentences with a plurality of labels. The processor 102 classifies the sentences into the types of fields they may have for instance, in conference pdfs, 1 sentence may only have title or may have title merged with author name. Several NLP based packages may be used for this, such as for example, NLTK( ). Each of the sentences are classified into different categories. In an embodiment, a multi label classification is used, such as for example, Fasttext. Each of the sentences may have more than one relevant field. So, if a sentence contains for instance both the Author and Affiliations classes, we will have both the labels from that sample. Consider for example, Sentence: Chan Xie, Dong-Ying Xie, Liang Peng, Zhi-Liang Gao Department of Infectious Disease, The Third Affiliated Hospital, Sun Yat-sen University, Guangzhou, China. Here the multi-label classification tag would be: AuAf, where Au denotes Author and Af denotes Affiliation.

In an embodiment, the one or more tokens are passed into a classifier for generating the plurality of lists.

In an embodiment, the system 100 employs a machine learning model 105 to generate a plurality of lists for identifying one or more fields in the text. In an embodiment, the plurality of lists includes at least a list of tokens, a list of tags and a list of confidence score of tokens. In an embodiment, the machine learning model 105 is a Cased-Sci-Bert Model®. The Cased-Sci-Bert Model® is case sensitive and gives better results than uncased Sci-Bert Model. In an embodiment, in the case of the Cased-Sci-Bert Model®, 512 tokens are passed into a classifier for generating the plurality of lists. In some embodiments, other known machine learning models may be used. In an embodiment, the processor 102 post processes the plurality of lists for extracting one or more fields for parsing the text. The plurality of lists includes at least a list of tokens, a list of tags and a list of confidence score of tokens. In an example scenario, consider 2400+ articles and noise data as well, the tag is annotated manually and fine-tune the data using python inbuilt library called NERDA®, which gives flexibility to use any model available in the Hugging Face®.

In an embodiment, while training the machine learning model 105, the below configuration is used:

| | |
|---|---|
| max_len=512, | |
| dropout=0.1, | |
| Hyperparameters= { | ‘epochs': 40, |
| | ‘warmup_steps': 400, |
| | ‘train_batch_size’: 100, |
| | ‘learning_rate’: 0.0001 } |

tokenizer_parameters={ ‘do_lower_case’: False }

Once the model is trained, the model is saved and is later loaded for inference. The model generates the tags for each token passed as input with a probability-based confidence score. While using the model for inference, one extra step of post processing will be required to get the output where the tags of the same class are combined to get relevant information as shown below:

‘Chan Xie, Dong-Ying Xie, Liang Peng, Zhi-Liang Gao’ −> 2(Author)
‘Department of Infectious Disease, The Third Affiliated Hospital, Sun Yat-sen
University, Guangzhou,China’ −> 3 (Affiliation).

After training the ML model 105 accuracy at token level is achieved. In an embodiment, the ML model 105 is trained using extracted text and the annotations. In an example scenario around 60 PDFs are manually annotated and around 2400 articles are curated to fine tune the ML model 105. Consider for example, the text “Disease, The Third Affiliated Hospital, Sun Yat-sen University, GuangZhou, China” This text contains author and affiliation and this is input to the ML model 105. The processor 102, tokenizes the text, which is simple space split. For example:

[‘Chan’, ‘Xie,’, ‘Dong-Ying’, ‘Xie,’, ‘Liang’, ‘Peng,’, ‘Zhi-Liang’, ‘Gao’, ‘Department’, ‘of’,
‘Infectious', ‘Disease,’, ‘The’, ‘Third’, ‘Affiliated’, ‘Hospital,’, ‘Sun’, ‘Yat-sen’, ‘University,’,
‘GuangZhou,’ ‘China’]

Subsequently the processor 102 puts the token into the ML model 105. The ML model 105 generates tokens as well as their tags in different lists such as for example, [2, 2, 2, 2, 2, 2, 2, 2, 3, 3, 3, 3, 3, 3, 3, 3, 3, 3, 3, 3, 3]. The processor 102 then performs a post-processing to split the tags and post-processes the output as:

‘Chan Xie, Dong-Ying Xie, Liang Peng, Zhi-Liang Gao’->2(Author) ‘Department of Infectious Disease, The Third Affiliated Hospital, Sun Yat-sen University, Guangzhou, China’->3 (Affiliation)

Subsequently, the processor 102 generates the text and the outputs along with confidence score in some embodiments. The confidence score determines the probability of classification of tags. In an embodiment, the highest confidence score corresponding to a tag and corresponding token is chosen by the processor 102 for classifying one or more fields in the text.

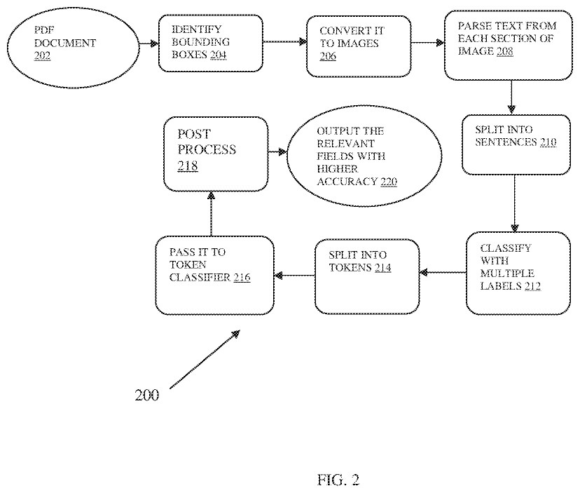

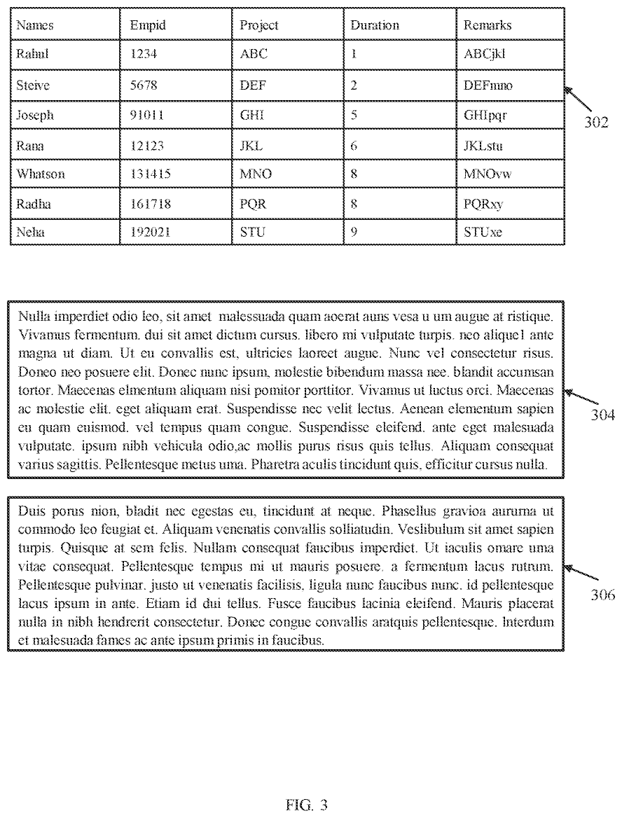

FIG. 2 depicts a block flow diagram illustrating the process of token-based classification for reducing overlap in field extraction during parsing of a text, in accordance with an embodiment. At step 202 a PDF document is received. At step 204, one or more bounding boxes are identified in the PDF document. At step 206, the bounding boxes are converted to images. At step 208, the text is parsed from each section of image. At step 210, the text from each section of the image is split into sentences. At step 212, the sentences are classified with multiple labels. At step 214, the classified sentences are split into tokens. At step 216, the tokens are passed to a token classifier. At step 218, the post processing is done. At step 220, the relevant fields with higher accuracy is output.

FIG. 3 depicts exemplary bounding boxes 302, 304, and 306 in a PDF document, in accordance with an exemplary scenario. The bounding boxes 302, 304, and 306 are converted to image format such as PNG or JPG and images will be created. In an embodiment, a python package such as CV2 or others is used for conversion to image format. Each of these bounding boxes 302, 304, and 306/images are split into sentences. The sentences are classified into the types of fields they may have. For instance, in conference pdfs, 1 sentence may only have title or may have tile merged with author name. Each of the sentences are classified into different categories. In an embodiment, multi label classification such as Fasttext is used since each of the sentences may have more than one relevant field. So, if a sentence contains for instance both the Author and Affiliations classes as shown below we will have both the labels from that sample.

Sentence: Chan Xie, Dong-Ying Xie, Liang Peng, Zhi-Liang Gao Department of Infectious Disease, The Third Affiliated Hospital, Sun Yat-sen University, Guangzhou, China
Multi-label classification tag: AuAf,
where Au denotes Author and Af denotes Affiliation.

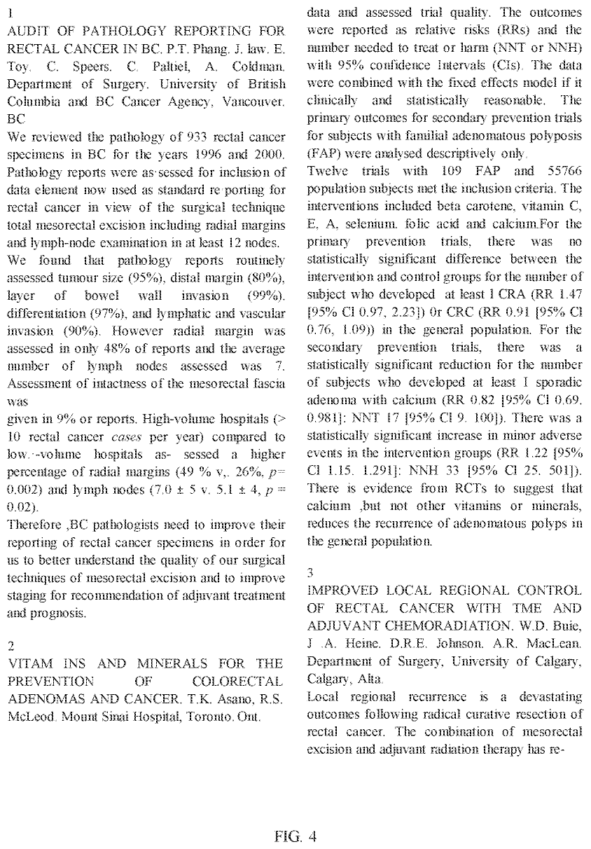

FIG. 4 depicts an excerpt from a PDF document, in accordance with an exemplary scenario. As can be observed from FIG. 4, the text includes title, authors and their affiliations continuously written in the same sentence. In order to determine where the title ends, we cannot use the NER model because there is no fixed type of entity present in the title. The present technology employs a token classification which can help us resolve such problems. The present system prepares training data by annotating sentences after parsing the documents. Note that, only those sentences are relevant for training which contains more than 1 label such as Author-Affiliation, Title-author, etc. Subsequently, 2400 articles are tagged and passed through the parsing model as above, selecting the samples with more than 1 tag. The sentences are split into tokens with white spaces using python packages. For example:

‘Chan Xie, Dong-Ying Xie, Liang Peng, Zhi-Liang Gao Department of Infectious Disease,
The Third Affiliated Hospital, Sun Yat-sen University, GuangZhou, China’

is split into:

[ ‘Chan’, ‘Xie,’, ‘Dong-Ying’, ‘Xie,’, ‘Liang’, ‘Peng,’, ‘Zhi-Liang’, ‘Gao’, ‘Department’, ‘of’,
‘Infectious', ‘Disease,’, ‘The’, ‘Third’, ‘Affiliated’, ‘Hospital,’, ‘Sun’, ‘Yat-sen’, ‘University,’,
‘GuangZhou,’ ‘China’ ]

A tag is assigned to each token based on its type. Consider, for example, only 4 fields are extracted from conference pdfs namely title, author, affiliation and abstract. All other text can be considered as noise as they are not relevant for us. In that scenario, the following tags are used:

0 for Noise
1 for Title
2 for Author
3 for Affiliation
4 for Abstract

This can be extended to any number of fields depending on the requirement. The tag for above sentence will look like:

```
[ ‘Chan’ : 2,
  ‘Xie,’ :2,
  ‘Dong-Ying’ ; 2,
  ‘Xie, : 2’,
  ‘Liang’ : 2,
  ‘Peng,’ : 2,
  ‘Zhi-Liang’ : 2,
  ‘Gao’ : 2,
  ‘Department’ : 3,
  ‘of’ : 3,
  ‘Infectious' : 3,
  ‘Disease,’ : 3,
  ‘The’ : 3,
  ‘Third’ : 3,
  ‘Affiliated’ : 3,
  ‘Hospital,’ : 3,
  ‘Sun’ : 3,
  ‘Yat-sen’ : 3,
  ‘University,’ : 3,
  ‘GuangZhou,’ : 3,
  ‘China’ : 3
  ]
```

There are several cases where more than 2 fields also get merged or they may not even be continuous. The annotated data is passed to the model for training the classification at token level. In an embodiment, a python inbuilt library called NERDA is used which gives flexibility to use any model available in the Hugging Face.

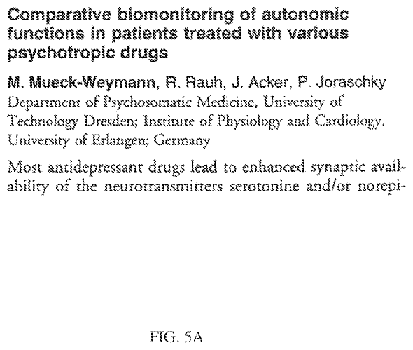

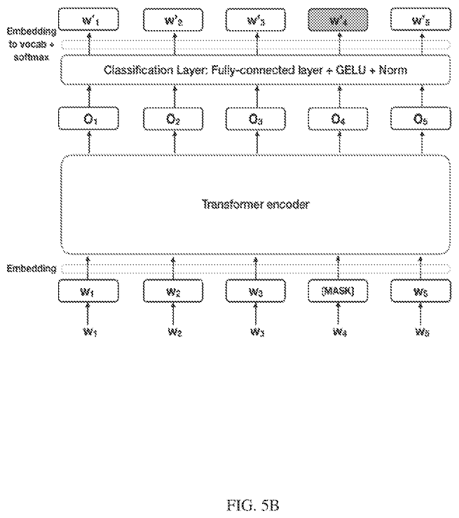

FIG. 5A depicts an exemplary text, in accordance with an exemplary scenario. As depicted in FIG. 5A, the sentence:
“M. Mueck-Weymann, R. Rauh, J. Acker, P. Joraschky Department of Psychosomatic Medicine, University of Technology Dresden; Institute of Physiology and Cardiology, University of Erlangen; Germany
Most antidepressant drugs lead to enhanced synaptic avail—ability of the neurotransmitters serotonine and/or norepi—”

The above sentence as we can see after extraction from the text gets merged and has different fields of Author, Affiliation and part of Abstract. In an embodiment, a Bidirectional Encoder Representations from Transformers (BERT) which is a Machine Learning (ML) model for natural language processing is used for training.

FIG. 5B depicts a pre-trained version of BERT model, in accordance with an exemplary scenario. In an embodiment, the model configuration is adjusted as per the need and training data. There are four types of pre-trained versions of BERT depending on the scale of the model architecture:
BERT-Base: 12-layer, 768-hidden-nodes, 12-attention-heads, 110M parameters
BERT-Large: 24-layer, 1024-hidden-nodes, 16-attention-heads, 340M

Before feeding word sequences into BERT, fifteen percent of the words in each sequence are replaced with a [MASK] token. The model then attempts to predict the original value of the masked words, based on the context provided by the other, non-masked, words in the sequence. In technical terms, the prediction of the output words requires:
Adding a classification layer on top of the encoder output.
Multiplying the output vectors by the embedding matrix, transforming them into the vocabulary dimension.
Calculating the probability of each word in the vocabulary with softmax.

In another embodiment, a SciBERT model which_is a BERT model trained on scientific text is used for training. The SciBERT is trained on papers from the corpus of semanticscholar.org. In an embodiment, the corpus size is 1.14M papers, 3.1B tokens. In an embodiment, the full text of the papers is used in training, not just abstracts. The SciBERT has its own vocabulary (scivocab) that is built to best match the training corpus.

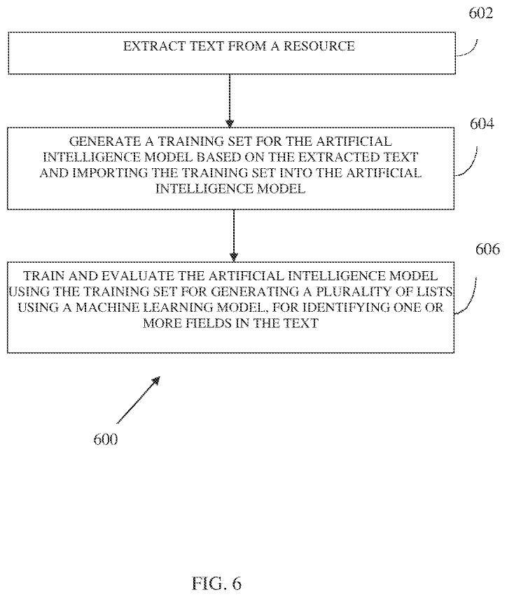

FIG. 6 illustrates a flow diagram 600 depicting processor-implemented method of training a machine learning model for token-based classification for reducing overlap in field extraction during parsing of a text, in accordance with an embodiment. At step 602, the method includes extracting text from a resource. At step 604, the method includes generating a training set for the artificial intelligence model based on the extracted text and importing the training set into the artificial intelligence model. At step 602, the method includes training and evaluating the artificial intelligence model using the training set for generating a plurality of lists for identifying one or more fields in the text, wherein the plurality of lists comprises at least a list of tokens, a list of tags and a list of confidence score of tokens. In an embodiment, performing the featurization includes positioning a distance weightage of amino acids in the two-dimensional numerical matrix next to a predetermined row and a predetermined column upon a predetermined criterion being satisfied.

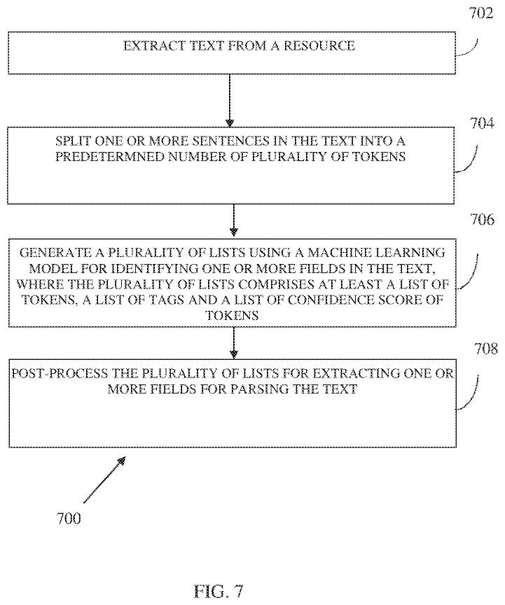

FIG. 7 illustrates a flow diagram 700 depicting a processor-implemented method of token-based classification for reducing overlap in field extraction during parsing of a text, in accordance with an embodiment. At step 702, the method includes extracting text from a resource. At step 704, the method includes splitting sentences in the text into a predetermined number of tokens. At step 706, the method includes generating a plurality of lists using a machine learning model, for identifying one or more fields in the text. The plurality of lists comprises at least a list of tokens, a list of tags and a list of confidence score of tokens. At step 708, the method includes post processing the plurality of lists for extracting one or more fields for parsing the text.

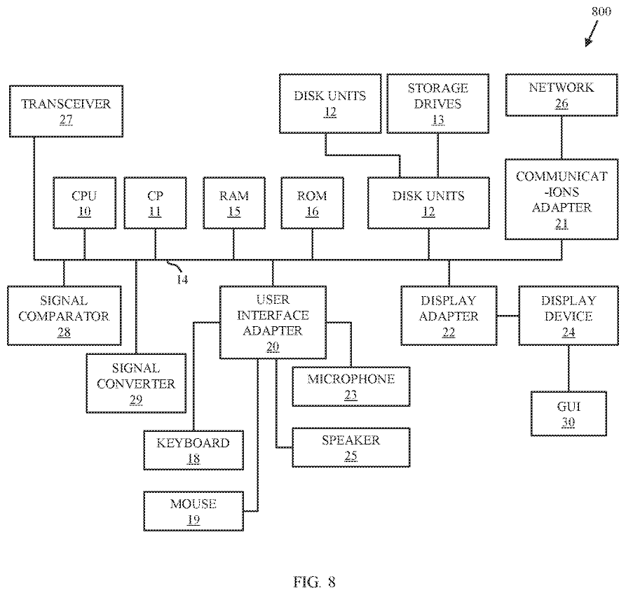

A representative hardware environment for practicing the embodiments herein is depicted in FIG. 8 with reference to FIGS. 1 through 7. This schematic drawing illustrates a hardware configuration of system 100 of FIG. 1, in accordance with the embodiments herein. The hardware configuration includes at least one processing device 10 and a cryptographic processor 11. The computer system 104 may include one or more of a personal computer, a laptop, a tablet device, a smartphone, a mobile communication device, a personal digital assistant, or any other such computing device, in one example embodiment. The computer system 104 includes one or more processors (e.g., the processor 108) or central processing unit (CPU) 10. The CPUs 10 are interconnected via system bus 12 to various devices such as a memory 14, read-only memory (ROM) 16, and an input/output (I/O) adapter 18. Although CPUs 10 are depicted, it is to be understood that the computer system 104 may be implemented with only one CPU.

The I/O adapter 18 can connect to peripheral devices, such as disk units 11 and tape drives 13, or other program storage devices that are readable by the system. The computer system 104 can read the inventive instructions on the program storage devices and follow these instructions to execute the methodology of the embodiments herein. The computer system 104 further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

Various embodiments of the present technology provides an efficient technique for converting protein data bank (PDB) files into a two-dimensional matrix that in turn reduces processing complexity and improves efficiency of processes the PDB files are subjected to in protein engineering such as featurization of PDB files. The present technology is extremely useful for the faster development of drugs such as HER2. Antibodies (Drugs) can be generated which are more effective at neutralizing the HER2 antigen. The present technology is also useful in other antibody optimization tasks in the bioinformatics domain.

The embodiments herein can include both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The system, method, computer program product, and propagated signal described in this application may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein.

Such software can be disposed in any known computer usable medium including semiconductor, magnetic disk, optical disc (e.g., CD-ROM, DVD-ROM, and the like) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location or have temporal limitations. For example, a processor can perform its functions in “real time,” “offline,” in a “batch mode,” etc. Portions of processing can be performed at different times and at different locations, by different (or the same) processing systems.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims. The scope of the embodiments will be ascertained by the claims to be submitted at the time of filing a complete specification.

What is claimed is:

1. A processor-implemented method of token-based classification for reducing overlap in field extraction during parsing of a text, the method comprising:
extracting the text from a resource;
splitting one or more sentences in the text into a predetermined number of plurality of tokens;
generating a plurality of lists using a machine learning model, for identifying one or more fields in the text, wherein the plurality of lists comprises at least a list of tokens, a list of tags and a list of confidence score of tokens; and
post-processing the plurality of lists for extracting one or more fields for parsing the text.

2. The processor-implemented method of claim 1, wherein extracting the text from the resource comprises:
receiving a PDF document and identifying one or more bounding boxes in text from the PDF document;
converting the one or more bounding boxes into a plurality of images; and
parsing the text from each section of the plurality of images.

3. The processor-implemented method of claim 1, wherein generating the plurality of lists comprises:
classifying the one or more sentences with a plurality of labels;
splitting the classified sentences into one or more tokens; and
passing the one or more tokens into a classifier for generating the plurality of lists.

4. A processor-implemented method of training a machine learning model for token-based classification for reducing overlap in field extraction during parsing of text, the method comprising:
extracting the text from a resource;
generating a training set for the artificial intelligence model based on the extracted text and importing the training set into the artificial intelligence model; and
training and evaluating the artificial intelligence model using the training set for generating a plurality of lists for identifying one or more fields in the text, wherein the plurality of lists comprises at least a list of tokens, a list of tags and a list of confidence score of tokens.

5. The processor-implemented method of claim 4, wherein the machine learning model is a Cased-Sci-Bert model.

6. A system for token-based classification for reducing overlap in field extraction during parsing of a text, the system comprising a processor configured to execute non-transitory machine-readable instructions that when executed perform:
extracting the text from a resource;
splitting one or more sentences in the text into a predetermined number of plurality of tokens;
generating a plurality of lists using a machine learning model, for identifying one or more fields in the text, wherein the plurality of lists comprises at least a list of tokens, a list of tags and a list of confidence score of tokens; and
post processing the plurality of lists for extracting one or more fields for parsing the text.

7. The system of claim 6, wherein extracting the text from the resource comprises:
receiving a PDF document and identifying one or more bounding boxes in text from the PDF document;
converting the one or more bounding boxes into a plurality of images; and
parsing the text from each section of the plurality of images.

8. The system of claim 6, wherein generating the plurality of lists comprises:
classifying the one or more sentences with a plurality of labels;
splitting the classified sentences into one or more tokens; and
passing the one or more tokens into a classifier for generating the plurality of lists.
